(19) United States
(12) Patent Application Publication
(10) Pub. No.: US 2025/0016559 A1
(43) Pub. Date: Jan. 9, 2025

(54) POST QUANTUM SECURITY PROFILE FOR JWE AND TLS IN 3GPP NETWORKS

(71) Applicant: Nokia Technologies Oy, Espoo (FI)

(72) Inventors: Aritra BANERJEE, Munich (DE); German Peinado Gomez, Wroclaw (PL); K Tirumaleswar Reddy, Bangalore (IN); Saurabh Khare, Bangalore (IN)

(21) Appl. No.: 18/749,970

(22) Filed: Jun. 21, 2024

(30) Foreign Application Priority Data
Jul. 3, 2023 (IN) 202311044589

(51) Int. Cl. H04W 12/0471

(52) U.S. Cl. CPC H04W 12/0471

(57) ABSTRACT

Method comprising:
informing a responding entity of two or more first key exchange schemes each comprising a respective key exchange supported by an initiating entity for a communication between the responding entity and the initiating entity;
receiving, from the responding entity, an indication of a selected key exchange scheme in response to the informing the responding entity of the two or more first key exchange schemes;
checking whether the selected key exchange scheme is a hybrid key exchange scheme; and, in response to checking that the selected key exchange scheme is not the hybrid key exchange scheme:
   rejecting the communication between the responding entity and the initiating entity; or
   performing the communication by exchanging a key according to the selected key exchange scheme and sending an alert indicating that the key exchange scheme different from the hybrid key exchange scheme is used for the communication.

### TECHNICAL FIELD

The present disclosure relates to authentication.

### Abbreviations

3GPP 3^{rd} Generation Partnership Project
5G/6G/7G 5^{th}/6^{th}/7^{th} Generation
AAD Additional Authenticated Data
AEAD Authenticated Encryption with Associated Data
AES Advanced Encryption Standard
API Application Programming Interface
CEK Content Encryption Key
CRQC Cryptographically Relevant Quantum Computer
ECDH Elliptic Curve Diffie-Hellman
GCM Galois/Counter Mode
HN Home Network
HTTP Hypertext Transfer Protocol
ID Identifier
IE Information Element
IETF Internet Engineering Task Force
IPX IP Exchange
JOSE JavaScript Object Signing & Encryption
JSON JavaScript Object Notation
JWE JSON Web Encryption
JWS JSON Web Signature
KEM Key Encapsulation Mechanism
NF Network Function
PQC Post-Quantum Cryptography
PQ/T Post-Quantum/Traditional (hybrid)
PRINS Protocol for N32 Interconnect Security
RAN Radio Access Network
RFC Request for Comments
RSA Reset-Request/Answer
SEPP Security Edge Protection Proxy
SN Serving Network
TLS Transport Layer Security
TS Technical Specification
UE User Equipment
UPF User Plane Function

### Glossary

“Post-Quantum Algorithm (PQC key exchange algorithm)”: An asymmetric cryptographic algorithm that is believed to be secure against attacks using quantum computers as well as classical computers. Examples of PQC key exchange algorithms include Kyber.

“Hybrid” key exchange, in this context, means the use of two key exchange algorithms based on different cryptographic assumptions, e.g., one traditional algorithm and one Post Quantum algorithm, with the purpose of the final shared master key being secure as long as at least one of the component key exchange algorithms remains unbroken. It is referred to as PQ/T Hybrid Scheme in draft-ietf-pquip-pqt-hybrid-terminology-00—Terminology for Post-Quantum Traditional Hybrid Schemes.

Examples of traditional key exchange algorithms are: Elliptic Curve Diffie Hellman (ECDH), RSA (Rivest Shamir Adelman), Diffie Hellman Key Exchange (DH), Pre-Shared Key (PSK).

Example of PQC algorithms are: Kyber, Bit Flipping Key Encapsulation (BIKE), Classic McEliece, Hamming Quasi-Cyclic (HQC).

PQ/T Hybrid Key Encapsulation Mechanism: A Key Encapsulation mechanism (KEM) made up of two or more component KEM algorithms where at least one is a post-quantum algorithm and at least one is a traditional algorithm.

Security Edge Protection Proxy (SEPP): The Security Edge Protection Proxy is a non-transparent proxy that sits at the perimeter of the PLMN network and enables secured communication for inter-PLMN network messages. The SEPP may support the following functions, inter alia:
Implements separate security negotiation interface (N32-c) and an end-to-end application interface (N32-f)
   N32-C: Uses for context management for security capability negotiation.
   N32-F: Uses for forwarding of inter-NF signaling across PLMNs.
Secure communication of Inter PLMN messages from Consumer NF to Producer NF using TLS protection mode (HTTP over TLS) or PRINS mode (via one or more IPXs).

### BACKGROUND

### Current 3GPP Work on JOSE JWE: PRINS (N32f Application Layer Protection)

The SEPP shall use JSON Web Encryption (JWE) as specified in RFC 7516 for the protection of reformatted HTTP messages between the SEPPs. All encryption schemes supported by JWE are AEAD methods, i.e., methods that encrypt and integrity protect in one single operation and can additionally integrity protect additional data.

The dataToIntegrityProtectAndCipher and dataToIntegrityProtect blocks shall be input to JWE as plaintext and JWE Additional Authenticated Data (AAD) respectively. The JWE AEAD algorithm generates JWE encrypted text (ciphertext) and a JWE Authentication Tag (Message Authentication Code). The ciphertext is the output from symmetrically encrypting the plaintext, while the authentication tag is a value that verifies the integrity of both the generated ciphertext and the Additional Authenticated Data.

The Flattened JWE JSON Serialization syntax shall be used to represent JWE as a JSON object.

The session key shared between the two SEPPs, as specified in clause 13.2.4.4.1 of 3GPP TS 33.501, shall be used as the Content Encryption Key (CEK) value to the algorithm indicated in the Encryption algorithm (“enc”) parameter in the JOSE header. The algorithm (“alg”) parameter in the JOSE header denoting the key exchange method shall be set to “dir”, i.e., “Direct use of a shared symmetric key as the CEK”.

### Key Exchanges

The N32-f key hierarchy is based on the N32-f master key generated during the N32-c initial handshake by TLS key export. The N32-f key hierarchy consists of two pairs of session keys and two pairs of IV salts, which are used in two different HTTP/2 sessions. In one of the sessions, the N32-c initiator acts as the HTTP client, and in the second one of the sessions, the N32-c responder acts as the client.

If the exported master key is reused to set up multiple HTTP sessions or to set up new HTTP sessions on stream ID exhaustion, a new, unique, N32-f Context ID shall be generated to avoid key and IV re-use.

### IPX Modification

The IPX through which the reformatted HTTP message passes shall use JSON Web Signature (JWS) as specified in RFC 7515 for the protection of IPX provider modified attributes. The mechanism described in this clause uses signatures, i.e., asymmetric methods, with private/public key pairs.

More specifically, when an IPX node modifies one or more attributes of the original HTTP message and creates a modifiedDataToIntegrityProtect object to record its modifications, it shall use JWS to integrity protect the modifiedDataToIntegrityProtect object.

### Verification by Receiving SEPP

The receiving SEPP shall decrypt the JWE ciphertext using the shared session key and the following parameters obtained from the JWE object—Initialization Vector, Additional Authenticated Data value (clearTextEncapsulatedMessage in “aad”) and JWE Authentication Tag (“tag”).

The receiving SEPP shall check the integrity and authenticity of the clearTextEncapsulatedMessage and the encrypted text by verifying the JWE Authentication Tag in the JWE object with the JWE AAD algorithm. The algorithm returns the decrypted plaintext (dataToIntegrityProtectAndCipher) only if the JWE Authentication Tag is correct.

The receiving SEPP refers to the NF API data-type placement mapping table to re-construct the original reformatted message by updating corresponding entries in clearTextEncapsulatedMessage with values in the dataToIntegrityProtectAndCipher array.

The receiving SEPP shall next verify IPX provider updates, if included, by verifying the JWS signatures added by the intermediary IPX(s) The receiving SEPP shall verify the JWS signature, using the corresponding raw public key or certificate that is contained in the IPX provider's security information list obtained during parameter exchange in the related N32-c connection setup or, alternatively, has been configured for the particular peer SEPP. It shall then check that the raw public key or certificate of the JWS signature IPX's Identity in the modifiedDataToIntegrity block matches to the IPX provider referred to in the “authorizedIPX ID” field added by the sending SEPP, based on the information given in the IPX provider security information list.

The receiving SEPP shall check whether the modifications performed by the intermediaries were permitted by the respective modification policies. The receiving SEPP shall use the modification policy of the cIPX obtained during parameter exchange in the related N32-c connection setup and use the modification policy of pIPX configured within the receiving SEPP. Details are described in 3GPP TS 33.501.

FIG. 1 shows an architecture according to the above discussed principles. The network functions and SEPPs on the left side and on the right side belong to different PLMNs. The prefix “c” means “consumer”, and the prefix “p” means “producer”. The SEPPs are connected by N32-c interface for initial handshake by TLS key export and N32-f interface for inter NF signaling across the PLMNs. One or more IPXs may be inserted on the path between cSEPP and pSEPP via the N32-f interface. The IPXs may be denoted as cIPX and pIPX, respectively, depending on whether they belong commercially to the consumer side or the producer side.

If cSEPP receives a HTTP/2 request from a NF (consumer) of the PLMN of the consumer side, it encrypts at least some IEs by JWE using the symmetric key A. Thus, the message towards pSEPP may comprise clear text IEs, by JWE encrypted IEs, and some metadata, as shown below cSEPP in FIG. 1. This message may be passed to pSEPP which generates the original HTTP/2 request and provides it to its NF (producer).

If there are one or more IPXs between cSEPP and pSEPP, according to PRINS, these IPXs may modify the clear text IEs by a respective JSON patch via JWS. The JSON patches are signed using the private key of the respective IPX. Thus, for each of the intermediary IPXs modifying the message by a respective JSON patch, pSEPP receives the JSON patch, an identifier of the IPX, and the signature, as shown below pSEPP in FIG. 1. pSEPP verifies that the JSON patch is actually provided by the respective IPX using the public key of the respective IPX. Furthermore, pSEPP may verify if the respective IPX is allowed to perform the modification. If the modification is accepted, pSEPP may accordingly adapt the HTTP/2 request sent to its NF (producer).

The message flow explained above with reference to FIG. 1 is for a message from consumer side to producer side. A message from producer side to consumer side will be handled correspondingly.

3GPP TS 33.501 (clause 13.2.4.9)—JOSE JWE profile for PRINS:

SEPPs shall follow the JWE profile defined in 3GPP TS 33.210 with the restriction that it shall only use AES GCM with a 128-bit or 256-bit key. The security considerations for the use of AES GCM in section 8.4 of RFC 7518 shall be taken into account. In particular, the same key shall not be used more than 2\hat{ }32 times and an IV salt shall not be used more than once with the same key.

Currently 3GPP specs include the use of JWE for PRINS protocol used to protect N32f interface in interconnection. JWE could be used in the near future for other security features from release 19 onwards, 6G, etc . . . 3GPP SA3 has created a JOSE JWE profile in 3GPP TS 33.210 that can be referenced by other specifications as a baseline.

### JOSE Profile in 3GPP TS 33.210 (Clause 6.3) JWE Profile:

### 6.3.1 General

JWS (JSON Web Signature) and JWE (JSON Web Encryption) are used to integrity protect and encrypt JSON objects. The JWE profile and JWS profile describe the restrictions and extensions to the RFCs for 3GPP entities or functions that support JWS and/or JWE.

The cipher suites used in clause 6.2 are described in RFC 7518.

### 6.3.2 JWE Profile

All entities and functions that support JWE according to RFC 7516 shall follow the following restrictions and extensions:
“enc” parameter A128GCM (AES GCM with a 128-bit key) shall be supported.
“enc” parameter A256GCM (AES GCM using 256-bit key) should be supported.
“alg” parameter “dir” (Direct use of a shared symmetric key as the CEK) shall be supported.

If ECDH is used as a key agreement protocol, the receiving party shall perform public key validation and check that the received public key is on the curve (of ECDH) agreed upon.

### SUMMARY

It is an object to improve the prior art.

According to a first aspect, there is provided an apparatus comprising:
one or more processors, and memory storing instructions that, when executed by the one or more processors, cause the apparatus to perform:
informing a responding entity of two or more first key exchange schemes each comprising a respective key exchange supported by an initiating entity for a communication between the responding entity and the initiating entity;
receiving, from the responding entity, an indication of a selected key exchange scheme in response to the informing the responding entity of the two or more first key exchange schemes;
checking whether the selected key exchange scheme is a hybrid key exchange scheme; and, in response to checking that the selected key exchange scheme is not the hybrid key exchange scheme:
   rejecting the communication between the responding entity and the initiating entity; or
   performing the communication by exchanging a key according to the selected key exchange scheme and sending an alert indicating that the key exchange scheme different from the hybrid key exchange scheme is used for the communication; wherein
the two or more first key exchange schemes comprise the hybrid key exchange scheme;
the hybrid key exchange scheme internally comprises at least two key exchanges based on different cryptographic assumptions.

The instructions, when executed by the one or more processors, may further cause the apparatus to perform
informing a requesting entity that the communication is rejected in response to checking that the selected key exchange scheme is not the hybrid key exchange scheme; wherein
the communication may be requested in response to a request from the requesting entity.

According to a second aspect, there is provided an apparatus comprising:
one or more processors, and memory storing instructions that, when executed by the one or more processors, cause the apparatus to perform:
receiving, at a responding entity, an information that an initiating entity supports two or more first key exchange schemes each comprising a respective key exchange for a communication between the responding entity and the initiating entity;
selecting one of first key exchange schemes as a selected key exchange scheme;
informing the initiating entity of the key exchange scheme in response to the receiving the information that the initiating entity supports the two or more first key exchange schemes, wherein
the two or more first key exchange schemes comprise a hybrid key exchange scheme;
the hybrid key exchange scheme comprises at least two key exchanges based on different cryptographic assumptions.

The instructions, when executed by the one or more processors, may further cause the apparatus to perform
checking whether the responding entity supports at least one of the two or more first key exchange schemes;
rejecting the communication in response to checking that the responding entity does not support at least one of the two or more first key exchange schemes.

For the apparatuses of each of the first and second aspects, one or more of the following may apply:
the communication may comprise at least one of a handshake and a transmission of a payload;
   the handshake may be a transport layer security handshake; or
   the payload may be a javascript object notation web encryption payload.
the hybrid key exchange scheme may comprise a traditional key exchange and a post-quantum key exchange; or
the entity is a network function or a security edge protection proxy.

According to a third aspect, there is provided a method comprising:
informing a responding entity of two or more first key exchange schemes each comprising a respective key exchange supported by an initiating entity for a communication between the responding entity and the initiating entity;
receiving, from the responding entity, an indication of a selected key exchange scheme in response to the informing the responding entity of the two or more first key exchange schemes;
checking whether the selected key exchange scheme is a hybrid key exchange scheme; and, in response to checking that the selected key exchange scheme is not the hybrid key exchange scheme:
   rejecting the communication between the responding entity and the initiating entity; or
   performing the communication by exchanging a key according to the selected key exchange scheme and sending an alert indicating that the key exchange scheme different from the hybrid key exchange scheme is used for the communication; wherein
the two or more first key exchange schemes comprise the hybrid key exchange scheme;
the hybrid key exchange scheme internally comprises at least two key exchanges based on different cryptographic assumptions.

The method may further comprise
informing a requesting entity that the communication is rejected in response to checking that the selected key exchange scheme is not the hybrid key exchange scheme; wherein
the communication may be requested in response to a request from the requesting entity.

According to a fourth aspect, there is provided a method comprising:
receiving, at a responding entity, an information that an initiating entity supports two or more first key exchange schemes each comprising a respective key exchange for a communication between the responding entity and the initiating entity;
selecting one of first key exchange schemes as a selected key exchange scheme;
informing the initiating entity of the key exchange scheme in response to the receiving the information that the initiating entity supports the two or more first key exchange schemes, wherein
the two or more first key exchange schemes comprise a hybrid key exchange scheme;
the hybrid key exchange scheme comprises at least two key exchanges based on different cryptographic assumptions.

The method may further comprise
checking whether the responding entity supports at least one of the two or more first key exchange schemes;
rejecting the communication in response to checking that the responding entity does not support at least one of the two or more first key exchange schemes.

For the methods of each of the third and fourth aspects, one or more of the following may apply:
the communication may comprise at least one of a handshake and a transmission of a payload;
   the handshake may be a transport layer security handshake; or
   the payload may be a javascript object notation web encryption payload.
the hybrid key exchange scheme may comprise a traditional key exchange and a post-quantum key exchange; or
the entity is a network function or a security edge protection proxy.

Each of the methods of the third and fourth aspects may be a method of secure communication.

According to a fifth aspect, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some example embodiments, at least one of the following advantages may be achieved:
“Harvest now, Decrypt later” attacks may be prevented;
Allows smooth transition to PQC;
Respects legacy implementations.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred example embodiments which is to be taken in conjunction with the appended drawings, wherein:

FIG. 1 shows an architecture according to the prior art on which some example embodiments may be applied;

FIG. 2 shows a message sequence chart according to some example embodiments;

FIG. 3 shows a message sequence chart according to some example embodiments;

FIG. 4 shows an apparatus according to an example embodiment;

FIG. 5 shows a message sequence chart according to some example embodiments;

FIG. 6 shows an apparatus according to an example embodiment;

FIG. 7 shows a method according to an example embodiment; and

FIG. 8 shows an apparatus according to an example embodiment.

### DETAILED DESCRIPTION OF CERTAIN EXAMPLE EMBODIMENTS

Herein below, certain example embodiments are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the disclosure to the disclosed details.

Moreover, it is to be understood that the apparatus is configured to perform the corresponding method, although in some cases only the apparatus or only the method are described.

The migration from traditional security schemes to PQC is unique in the history of modern digital cryptography in that neither the traditional algorithms nor the post-quantum algorithms are fully trusted to protect data for the required data lifetimes. The traditional algorithms, such as RSA and elliptic curve, may fall to quantum cryptanalysis, while the post-quantum algorithms face uncertainty about the underlying mathematics, compliance issues, unknown vulnerabilities, hardware and software implementations that have not had sufficient maturing time to rule out classical cryptanalytic attacks and implementation bugs. During the transition from traditional to post-quantum algorithms, there is a desire or a requirement for protocols that use both algorithm types.

In particular, the public key-based cryptography (e.g., ECDH) algorithms used in the JWE profiles (that are standardized in 3GPP) may be broken and become obsolete in the presence of a Cryptographically Relevant Quantum Computer (CRQC), which can perform quantum cryptanalysis. Basically, some example embodiments aim to avoid that a potential attacker with quantum cryptanalytic capabilities will be able to derive the private key out of the public key exchanged with the other party and decrypt the shared encryption key used in JWE. It is referred to as “Harvest Now, Decrypt Later” attack, which refers to an attacker collecting encrypted data now and waiting for quantum computers to become powerful enough to break the encryption later.

Considering the SEPP uses JOSE JWE for the encryption, the SEPP or operator traffic will also be under threat so migration into PQC is required as well. Similar problems may arise in 3GPP deployment which uses JWE or going to use JWE, therefore common solution is also required for any 3GPP NF/Nodes using JWE.

According to some example embodiments, the protection of inter-PLMN traffic by SEPP is enhanced by at least one of the following:

1) N32c negotiation update:

The network functions may be enable hybrid key exchange for at least one of TLS and JWE (for example, for both of TLS and JWE).

TLS: Updating the TLS stack and profile on the client and server to support hybrid key exchange, e.g. according to the design described by https://datatracker.ietf.org/doc/draft-ietf-tls-hybrid-design (currently version 06 is available). If one of the TLS peers does not support the hybrid-key exchange, the other TLS peer rejects the TLS handshake, typically with an appropriate alert (e.g. “Harvest Now, Decrypt Later” attack alert) to prevent a down-grade attack, OR does not reject the TLS handshake but raises an attack alert.

The hybrid TLS profile may use both traditional and PQC algorithms for key exchange and in future, the TLS profile can be upgraded to only use PQC algorithms for key exchange. The hybrid TLS profile may be initially deployed without any update to the client/server certificates, but these certificates may be upgraded to either composite signatures (using both traditional and PQC signatures) or signatures generated using Post Quantum signature algorithms. The network functions may support cryptographic agility and backward compatibility to dynamically update the TLS profile used by the network functions to address classical and quantum cryptanalysis.

JWE: Update of the JWE profile to use the hybrid encryption scheme (an encryption scheme comprising a hybrid key exchange). If the hybrid encryption scheme is not used, reject the JWE payload. Additionally, the receiver of the JWE payload may raise an alert to notify a management system on the potential “Harvest Now, Decrypt Later” attack.

The hybrid JWE profile may also use both traditional and PQC algorithms for key exchange and in future, the JWE profile may be upgraded to only use PQC algorithms. The hybrid JWE profile may be initially deployed with composite keys (Traditional+Post Quantum) in the receiver's certificate, these certificates may be later upgraded to use composite signatures (Traditional+Post Quantum) or signatures using Post Quantum signature algorithms. It will enable JSON Web Signature (JWS) to use PQC signature algorithms (e.g., Falcon). The network functions may support cryptographic agility and backward compatibility to dynamically update the JWE profile used by network functions to address classical and quantum cryptanalysis.

### 2) Update of PRINS (N32f)

The update of the JWE profile may be described in 3GPP TS 33.210. Thus, it can be referenced in any future use of JWE in 3GPP standards (Rel.19, 6G, etc.). By applying a Post Quantum Hybrid Key Exchange mechanism, the JWE profile gains robustness against potential vulnerabilities found in the future against Traditional or Post Quantum algorithms. Thus, the profile is secure even if one of the two used mechanisms (Traditional and Post Quantum) is broken.

The specific problem of PRINS JWE schema is addressed by https://datatracker.ietf.org/doc/draft-ietf-tls-hybrid-design. This draft proposes a hybrid key exchange construction in TLS 1.3, that may be applied in the TLS establishment of N32-c required to exchange the symmetric share key to be used in JWE.

### 3) Update of TLS N32f

The update of the TLS profile may be described in 3GPP TS 33.210. Thus, it can be referenced in any future use of JWE in 3GPP standards (Rel.19, 6G, etc.). By applying a Post Quantum Hybrid Key Exchange mechanism, the hybrid TLS profile gains robustness against potential vulnerabilities found in the future against Traditional or Post Quantum algorithms. Thus, the profile is secure even if one of the two used mechanisms (Traditional and Post Quantum) is broken.

The update of N32c interface may be generalized to any communication between two arbitrary NFs using TLS or JWE.

TLS: Updating the TLS stack and profile on the client and server to support hybrid key exchange, e.g. according to the design described by https://datatracker.ietf.org/doc/draft-ietf-tls-hybrid-design. If one of the TLS peers does not support the hybrid-key exchange, the other TLS peer may reject the TLS handshake and typically issue an appropriate alert (e.g. “Harvest Now, Decrypt Later” attack alert) to prevent a down-grade attack, OR the other TLS peer may not reject the TLS handshake but raises an attack alert.

Which of the two options is applied may be implementation specific. In some example embodiments, both options may be implemented and the other TLS peer decides according to some criteria which option to apply. For example, the other peer may decide based on the sensitivity of the exchanged information whether to reject the TLS handshake (with or without an alert), or to accept the TLS handshake and to raise an alert. The higher the sensitivity, the higher the likelihood for rejection of the TLS handshake.

JWE: Update of the JWE profile to use the hybrid encryption scheme. If the hybrid encryption scheme is not used, the communication partner may reject the JWE payload, typically with raising an alert to notify a management system on the potential “Harvest Now, Decrypt Later” attack. Node/NF generates the shared master key based on the hybrid key and provides protection again different attacks.

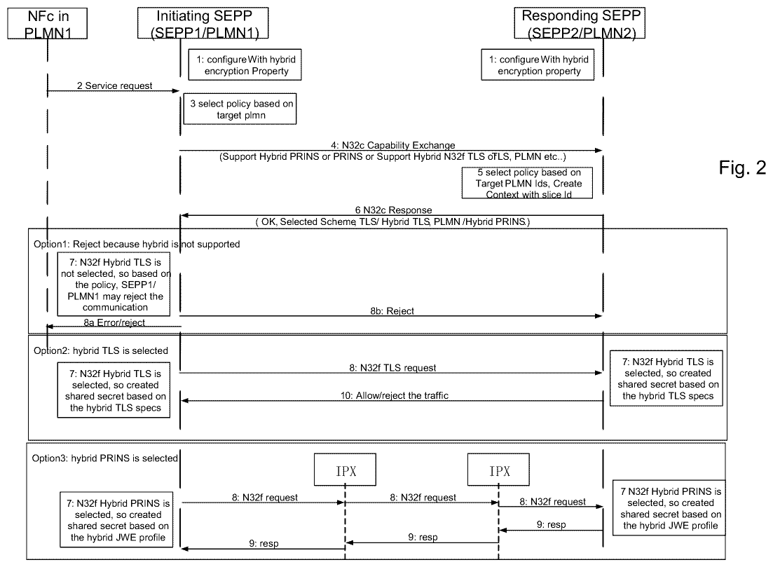

FIG. 2 shows a message sequence chart according to some example embodiments for the case of a communication between an Initiating SEPP (also called SEPP1) of PLMN1 and a responding SEPP (also called SEPP2) of PLMN2 different from PLMN1. The actions are as follows:
Action 1: Both SEPPs are configured with hybrid key exchange for both TLS and JWE.
Actions 2,3: When a service request from a NFc of PLMN1 is received at the SEPP1, the SEPP selects the supported security scheme (including the key exchange scheme) for the PLMN. As another option, SEPP1 may negotiate the supported security scheme with SEPP2 during bootup time over N32c interface.
Action 4: SEPP1 sends the supported security scheme to SEPP2 and additionally includes the supported key exchange mechanisms. For example, SEPP1 may inform SEPP2 that SEPP1 supports (“TLS” and “PRINS” mean “conventional TLS” and “conventional PRINS”, respectively):
TLS
PRINS
Supported hybrid PRINS
Supported hybrid TLS
Supported PQC PRINS
Supported PQC TLS

In some example embodiments, the initiating SEPP (SEPP1) may not inform the responding SEPP (SEPP2) on one or both of the conventional options (TLS and PRINS). Thus, SEPP1 forbids SEPP2 to fallback to this or these conventional method(s). In some example embodiments, the initiating SEPP (SEPP1) may not inform the responding SEPP (SEPP2) on one or both of the PQC options (PQC TLS and PQC PRINS). The information may comprise at least one of the hybrid options (hybrid PRINS and/or hybrid TLS).

Actions 5,6: Responding SEPP (SEPP2) selects the policy based on the peer PLMN (i.e. PLMN1). If SEPP2 does not support any of the indicated key exchange methods (in particular: no hybrid method), the responding SEPP rejects the request. The rejection may comprise an appropriate error code. Otherwise, responding SEPP selects one of the offered key exchange schemes and responds with the selected scheme.

The further processing depends on the key exchange scheme selected by the responding SEPP:
Option 1: The selected key exchange scheme is not a hybrid key exchange
Action 7: If, according to a policy of PLMN1, a hybrid key exchange scheme is required, PLMN1 rejects the request.

Actions 8a, 8b: SEPP1 informs SEPP2 and the requesting NFc on the rejection.
Option 2: SEPP2 selects hybrid TLS.
Action 7: Both SEPPs generate the shared master key based on TLS profile to use the hybrid encryption scheme and encrypt the data accordingly.
Action 8: Based on the shared master key, initiating SEPP sends a TLS request on N32f interface.
Action 10: SEPP2 allows or rejects the traffic on N32f.
Option 3: SEPP2 selects hybrid PRINS.
Action 7: Both SEPPs generate the shared master key based on JWE profile to use the hybrid encryption scheme and encrypt the data accordingly.

Actions 8, 9: A communication using the shared master key is performed between SEPP1 and SEPP2 via one or more IPXs.

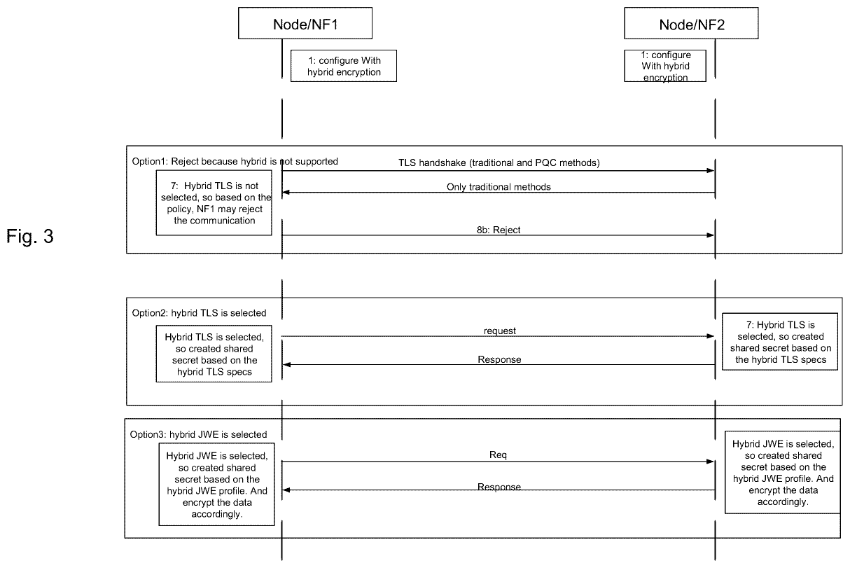

FIG. 3 shows a further example embodiment. This message flow corresponds to that of FIG. 2, except that the SEPPS are replaced by general Nodes or NFs.

JOSE: The general solution for NFs using JOSE would be to use hybrid key exchange in JOSE to prevent “Harvest Now, Decrypt Later” attack. In future, where an on-path attacker possesses network devices equipped with CRQC, capable of breaking JWS and the signature schemes used in JOSE will have to upgraded to use PQC signature schemes.

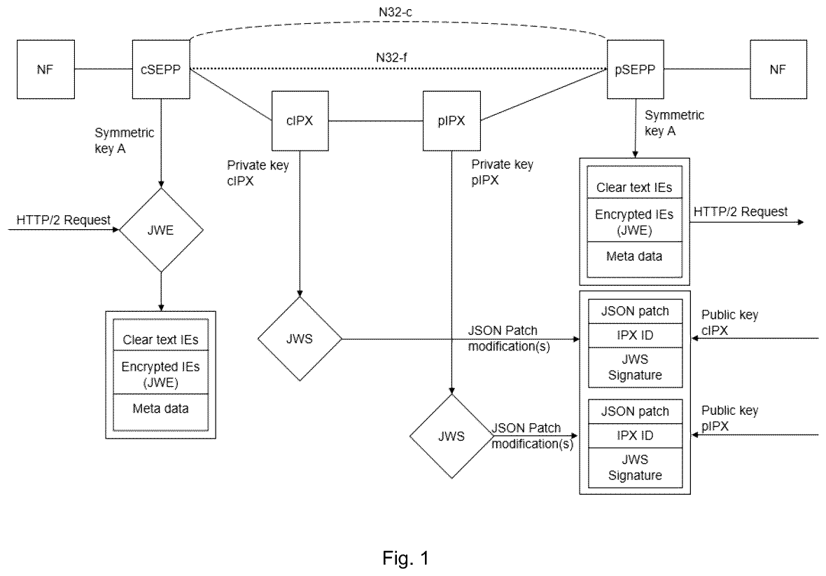

As may be seen from the 3 options in FIGS. 1 and 2, if both nodes support the hybrid key exchange scheme, they may negotiate and generate the shared master key. If any node is not supporting hybrid scheme, then NF/node can reject the request (option1). If both nodes support hybrid scheme, they may use shared master key for TLS encryption (option2) or use shared master key for JWE encryption (option3).

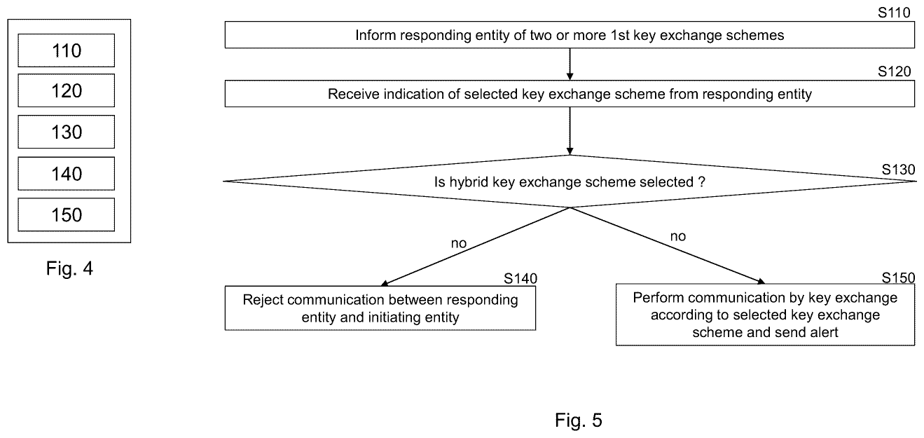

FIG. 4 shows an apparatus according to an example embodiment. The apparatus may be a network function (such as an initiating network function, e.g. a SEPP) or an element thereof. FIG. 5 shows a method according to an example embodiment. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises means for informing 110, means for receiving 120, means for checking 130, and at least one of means for rejecting 140 or means for performing 150. The means for informing 110, means for receiving 120, means for checking 130, means for rejecting 140, and means for performing 150 may be an informing means, receiving means, checking means, rejecting means, and performing means, respectively. The means for informing 110, means for receiving 120, means for checking 130, means for rejecting 140, and means for performing 150 may be an informer, receiver, checker, rejector, and performer, respectively. The means for informing 110, means for receiving 120, means for checking 130, means for rejecting 140, and means for performing 150 may be an informing processor, receiving processor, checking processor, rejecting processor, and performing processor, respectively.

The means for informing 110 informs a responding entity of one or more first key exchange schemes (S110). Each of the key exchange schemes comprises a respective key exchange supported by an initiating entity. The key exchange may be used for a communication between the responding entity and the initiating entity. The one or more first key exchange schemes comprise a hybrid key exchange scheme. The hybrid key exchange scheme comprises at least two key exchanges based on different cryptographic assumptions.

In response to the informing the responding entity of the one or more first key exchange schemes of S110, the means for receiving 120 receives, from the responding entity, an indication of a second key exchange scheme (S120).

The means for checking 130 checks whether the second key exchange scheme is the hybrid key exchange scheme (S130).

In response to checking that the second security scheme is not the hybrid key exchange scheme (S130=no):
the means for rejecting 140, if implemented in the apparatus, rejects the communication between the responding entity and the initiating entity (S140); or
the means for performing 150, if implemented in the apparatus, performs the communication by exchanging a key according to the second key exchange scheme and sends an alert indicating that the second key exchange scheme different from the hybrid key exchange scheme is used for the communication (S150).

If the apparatus comprises both the means for rejecting 140 and the means for performing 150, a means for selecting may select whether the means for rejecting 140 or the means for performing 150 acts on the communication. The selection may be based on criteria such as a sensitivity of the communication, a type of the responding network function, an identifier of the responding network function, etc.

The entity may be a network function such as a SEPP.

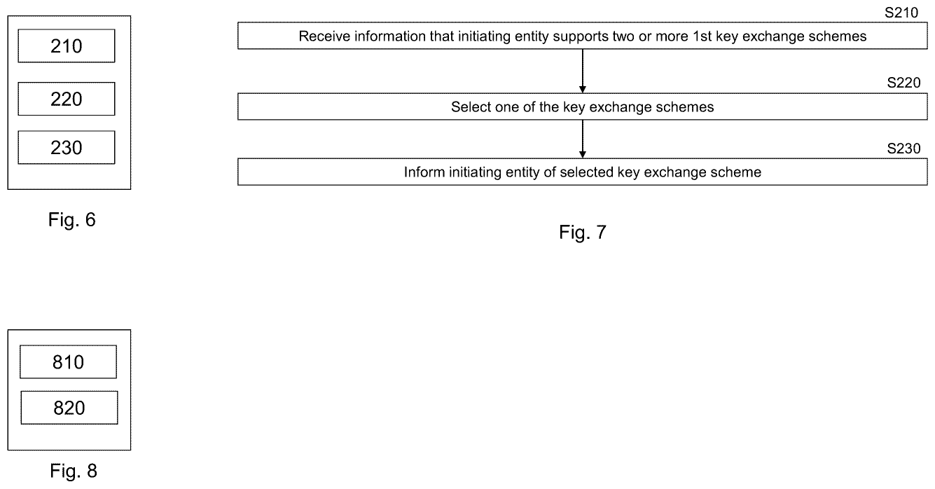

FIG. 6 shows an apparatus according to an example embodiment. The apparatus may be a network function (such as an initiating network function, e.g. a SEPP) or an element thereof. FIG. 7 shows a method according to an example embodiment. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for receiving 210, means for selecting 220, and means for informing 230. The means for receiving 210, means for selecting 220, and means for informing 230 may be a receiving means, selecting means, and informing means, respectively. The means for receiving 210, means for selecting 220, and means for informing 230 may be a receiver, selector, and informer, respectively. The means for receiving 210, means for selecting 220, and means for informing 230 may be a receiving processor, selecting processor, and informing processor, respectively.

The means for receiving 210 receives, at a responding entity, an information that an initiating entity supports one or more first key exchange schemes (S210). Each of the first key exchange schemes comprises a respective key exchange for a communication between the responding entity and the initiating entity. The one or more first key exchange schemes comprise a hybrid key exchange scheme. The hybrid key exchange scheme comprises at least two key exchanges based on different cryptographic assumptions.

The means for selecting 220 selects one of the one or more first key exchange schemes as a second key exchange scheme (S220). The means for informing 230 informs the initiating entity of the second key exchange scheme in response to the receiving the information that the initiating entity supports the one or more first key exchange schemes of S210 (S230).

The entity may be a network function such as a SEPP.

FIG. 8 shows an apparatus according to an example embodiment. The apparatus comprises at least one processor 810, at least one memory 820 storing instructions that, when executed by the at least one processor 810, cause the apparatus at least to perform the method according to at least one of the following figures and related description: FIG. 5, or FIG. 7.

Some example embodiments are explained with respect to 5G (NR). However, other example embodiments may be employed in other 3GPP generations, such as 4G, 6G, 7G, etc., in other wireless or wired communication networks, and in other systems employing TLS and/or JWE.

A UE is an example of a terminal. Other examples are MTC devices. Each of the terminals may be implemented as a smartphone, a mobile phone, a laptop, a sensor device etc.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments provide, for example, a network function (such as an initiating network function or a responding network function, or an element thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments. However, it should be noted that the description of the preferred example embodiments is given by way of example only and that various modifications may be made without departing from the scope of the disclosure as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1. Apparatus comprising:
one or more processors, and memory storing instructions that, when executed by the one or more processors, cause the apparatus to perform:
informing a responding entity of two or more first key exchange schemes each comprising a respective key exchange supported by an initiating entity for a communication between the responding entity and the initiating entity;
receiving, from the responding entity, an indication of a selected key exchange scheme in response to the informing the responding entity of the two or more first key exchange schemes;
checking whether the selected key exchange scheme is a hybrid key exchange scheme; and, in response to checking that the selected key exchange scheme is not the hybrid key exchange scheme:
rejecting the communication between the responding entity and the initiating entity; or
performing the communication by exchanging a key according to the selected key exchange scheme and sending an alert indicating that the key exchange scheme different from the hybrid key exchange scheme is used for the communication; wherein
the two or more first key exchange schemes comprise the hybrid key exchange scheme;
the hybrid key exchange scheme internally comprises at least two key exchanges based on different cryptographic assumptions.

2. The apparatus according to claim 1, wherein the instructions, when executed by the one or more processors, further cause the apparatus to perform
informing a requesting entity that the communication is rejected in response to checking that the selected key exchange scheme is not the hybrid key exchange scheme; wherein
the communication is requested in response to a request from the requesting entity.

3. The apparatus according to claim 1, wherein the communication comprises at least one of a handshake and a transmission of a payload.

4. The apparatus according to claim 3, wherein at least one of:
the handshake is a transport layer security handshake; or
the payload is a javascript object notation web encryption payload.

5. The apparatus according to claim 1, wherein the hybrid key exchange scheme comprises a traditional key exchange and a post-quantum key exchange.

6. The apparatus according to claim 1, wherein the entity is a network function or a security edge protection proxy.

7. Apparatus comprising:
one or more processors, and memory storing instructions that, when executed by the one or more processors, cause the apparatus to perform:
receiving, at a responding entity, an information that an initiating entity supports two or more first key exchange schemes each comprising a respective key exchange for a communication between the responding entity and the initiating entity;
selecting one of first key exchange schemes as a selected key exchange scheme;
informing the initiating entity of the key exchange scheme in response to the receiving the information that the initiating entity supports the two or more first key exchange schemes, wherein
the two or more first key exchange schemes comprise a hybrid key exchange scheme;
the hybrid key exchange scheme comprises at least two key exchanges based on different cryptographic assumptions.

8. The apparatus according to claim 7, wherein the instructions, when executed by the one or more processors, further cause the apparatus to perform
checking whether the responding entity supports at least one of the two or more first key exchange schemes;
rejecting the communication in response to checking that the responding entity does not support at least one of the two or more first key exchange schemes.

9. The apparatus according to claim 7, wherein the communication comprises at least one of a handshake and a transmission of a payload.

10. The apparatus according to claim 9, wherein at least one of:
the handshake is a transport layer security handshake; or
the payload is a javascript object notation web encryption payload.

11. The apparatus according to claim 7, wherein the hybrid key exchange scheme comprises a traditional key exchange and a post-quantum key exchange.

12. The apparatus according to claim 7, wherein the entity is a network function or a security edge protection proxy.
